(19) United States
(12) Patent Application Publication
(10) Pub. No.: US 2013/0063944 A1
(43) Pub. Date: Mar. 14, 2013

(54) Tubular Light Emitting Diode Lamp

(71) Applicants: Pervaiz Lodhie, Rolling Hills, CA (US); Bruce Johnson, Torrance, CA (US)

(72) Inventors: Pervaiz Lodhie, Rolling Hills, CA (US); Bruce Johnson, Torrance, CA (US)

(21) Appl. No.: 13/228,820

(22) Filed: Sep. 9, 2011

(51) Int. Cl. F21V 21/00

(52) U.S. Cl. 362/249.02

(57) ABSTRACT

A tubular light-emitting diode (LED) lamp including a planar printed circuit board (PCB) with a first side and a second side, wherein the planar PCB is positioned within a tubular sheath; a first plurality of light-emitting diodes (LEDs) mounted on the first side, wherein at least one of the first plurality of LEDs is mounted substantially perpendicular to the first side; a second plurality of LEDs mounted on the second side, wherein at least one of the second plurality of LEDs is mounted substantially perpendicular to the second side; an electrical end cap coupled at a first end of the PCB; and a non-electrical end cap coupled at a second end of the PCB, wherein the first end and the second end are at opposite ends of the tubular sheath. In one example, the LED lamp includes a capacitor reactance ballasted power supply for supplying voltage to the LEDs.

### FIELD

This disclosure relates generally to light emitting diode lamps. More particularly, the disclosure relates to tubular light emitting diode lamps.

### BACKGROUND

A light-emitting diode (LED) is a diode that emits light when a current passes through it. A diode is a semiconductor device through which current can pass in only one direction. LEDs may be used as indicator lights, for example, in light panels on the dashboard of automobiles or on computers and printers, etc. In some cases, a single LED replaces a conventional tungsten bulb for small area lighting.

LEDs are in general more efficient, longer lasting and more durable than fluorescent and incandescent lamps. In one example, LEDs are about 4 times more efficient at producing light than fluorescent lamps, and about 16 times more efficient at producing light than incandescent lamps. Unlike fluorescent and incandescent lamps, LEDs are extremely shock resistant. While an incandescent lamp may produce light for, for example, 750 to 2,000 operating hours, and a fluorescent lamp may produce light for, for example, 12,000 to 24,000 hours of continuous use, many LEDs can produce light for approximately 100,000 hours of continuous use. For the above reasons, LEDs are generally preferred over fluorescent and incandescent lamps in applications where energy efficiency and longer lasting use are critical.

### SUMMARY

Disclosed is a light emitting diode (LED) lamp. According to one aspect, a tubular light-emitting diode (LED) lamp including a planar printed circuit board (PCB) with a first side and a second side, wherein the planar PCB is positioned within a tubular sheath; a first plurality of light-emitting diodes (LEDs) mounted on the first side, wherein at least one of the first plurality of LEDs is mounted substantially perpendicular to the first side; a second plurality of LEDs mounted on the second side, wherein at least one of the second plurality of LEDs is mounted substantially perpendicular to the second side; an electrical end cap coupled at a first end of the planar PCB; and a non-electrical end cap coupled at a second end of the planar PCB, wherein the first end and the second end are at opposite ends of the tubular sheath.

According to another aspect, a tubular light-emitting diode (LED) lamp including a planar printed circuit board (PCB) with a first side and a second side, wherein the planar PCB is positioned within a tubular sheath; a first plurality of light-emitting diodes (LEDs) mounted on the first side, wherein a substantial quantity of the first plurality of LEDs is mounted substantially perpendicular to the first side; a second plurality of LEDs mounted on the second side, wherein the second plurality of LEDs is mounted substantially perpendicular to the second side; an electrical end cap coupled at a first end of the planar PCB; a non-electrical end cap coupled at a second end of the planar PCB, wherein the first end and the second end are at opposite ends of the tubular sheath; and a capacitor reactance ballasted power supply for supplying electrical voltage to the first plurality of LEDs and the second plurality of LEDs.

Advantages of the present disclosure may include energy efficiency, longer lasting light emission and more durability as compared to conventional tungsten lamps.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a tubular light emitting diode lamp 10 in accordance with the present disclosure.

FIG. 2a illustrates a first example of a side elevation view of the tubular light emitting diode lamp 10 of FIG. 1.

FIG. 2b illustrates a second example of a side elevation view of the tubular light emitting diode lamp 10 of FIG. 1.

FIG. 3a illustrates a side elevation view of the example tubular light emitting diode lamp shown in FIG. 1 where a second side of the planar printed circuit board (PCB) opposite a first side is visible through a sheath.

FIG. 3b illustrates an example of the second plurality of LEDs mounted on the second side of the PCB.

FIG. 4 illustrates an example circuit diagram of an electrical circuit for illuminating the LEDs.

FIG. 5 illustrates an example of a light fixture for housing a tubular light emitting diode lamp.

FIG. 6 illustrates a front elevation view of the example light fixture shown in FIG. 5.

FIG. 7 illustrates a cross-section view of the example light fixture as indicated in FIG. 6.

FIG. 8 illustrates another cross-section view of the example light fixture as indicated in FIG. 6.

FIG. 9 illustrates an example of a circuit for applying electrical power to a tubular light emitting diode lamp housed in a light fixture.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

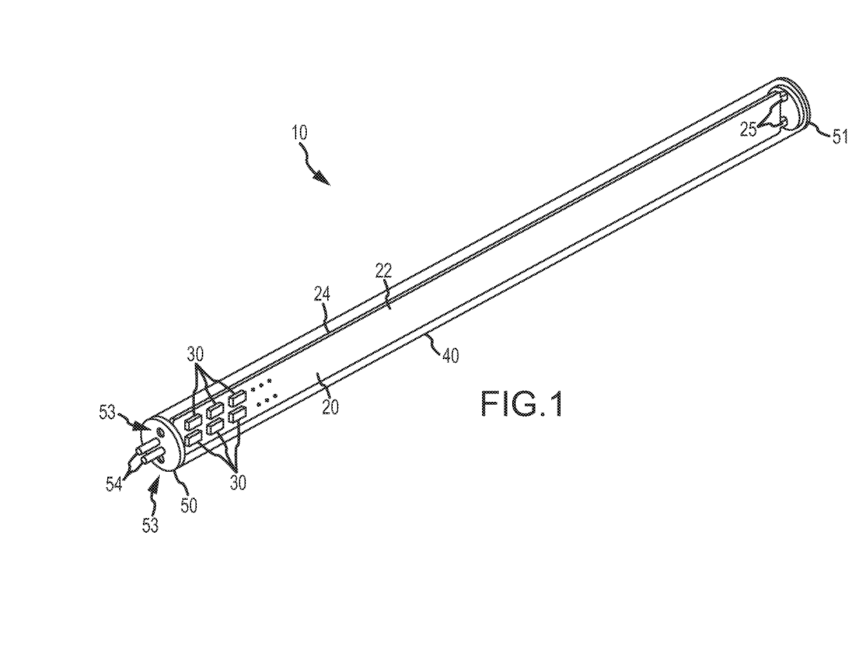

FIG. 1 illustrates an example of a tubular light emitting diode lamp 10 in accordance with the present disclosure. The tubular light emitting diode lamp 10 includes a substantially planar printed circuit board (PCB) 20 with a first side 22 and a second side 24 opposite the first side. A plurality of light-emitting diodes (LEDs) 30 is mounted along a first side 22 of the substantially planar printed circuit board (PCB) 20. In one example, one or more of the plurality of LEDs is mounted substantially perpendicular to the PCB 20.

In one example, the plurality of LEDS are arranged to form two LED arrays. One skilled in the art would understand that although two LED arrays are shown, the present disclosure is not limited to two LED arrays and that other quantities of LED arrays are also within the scope and spirit of the present disclosure. Although not shown in FIG. 1, one or more light-emitting diodes (LEDs) 30 is mounted substantially perpendicular along a second side 24 of the substantially planar printed circuit board (PCB) 20.

In one example, the PCB 20 is positioned within a tubular sheath 40. Light emitted by the plurality of LEDs mounted along the first side of the PCB 20 and light emitted by the one or more LEDs mounted along the second side of the PCB 20 passes through the tubular sheath 40.

In one example, the tubular sheath 40 is a hollow cylinder made of a material substantially transparent to visible light (i.e., substantially “clear”). The plurality of LEDs and the one or more LEDs mounted on the first and second sides, respectively, of the PCB 20 are visible through the tubular sheath 40.

The tubular light emitting diode lamp 10 includes two ends caps installed at opposite ends of the tubular sheath 40 and are adapted to properly position and hold the PCB 20 in the tubular sheath 40. In one example, one end cap 50 is an electrical end cap which allows current conduction and the other end cap 51 is a non-electrical end cap which does not allow current conduction. In one example, the electrical end cap 50 is an electrical bi-pin connector end cap. In one example, the non-electrical end cap 51 is a mechanical support bracket.

In one example, the PCB 20 has two opposed ends, and each end has two projections 25 extending outwardly therefrom. One of the ends corresponds to the electrical end cap 50 and the other end corresponds to the non-electrical end cap 51. As shown in FIG. 1, the electrical end cap 50 has two holes 53 and 53 adapted to receive the corresponding projections of the PCB 20. The non-electrical end cap 51 also has two holes for receiving the corresponding projections of the PCB 24. When the end caps 50, 51 are inserted into the opposite ends of the tubular sheath 40 such that the projections of the PCB 20 reside in the corresponding holes in the end caps 50, 51, the PCB 20 is properly positioned and held in the tubular sheath 40.

In one example, tubular light emitting diode lamp 10 is intended to advantageously replace a preheat-type (or instant or rapid start) fluorescent lamp, having a bi-pin base on each end, in a light fixture adapted to receive preheat-type (or instant or rapid start) fluorescent lamps. Accordingly, the end cap 50 (which is electrical) has two pins 54 extending outward therefrom in parallel for connecting to an electrical power source. In one example, the end cap 51 (which is non-electrical) includes two non-conductive pins 55 (not shown). The pins 54 and 55 are adapted for insertion into bi-pin lamp holders of the light fixture.

In one example, the electrical pins 54 are connected together, and two wires having an alternating current voltage between them are connected to the pins 54 to provide electrical power to the tubular light emitting diode lamp 10. In another example, tubular light emitting diode lamp 10 is adapted for use with DC voltage. In one example, a capacitor reactance ballasted circuit functions as a power supply for the tubular light emitting diode lamp.

The plurality of LEDs 30 emits visible light. In one example, the LEDs 30 are surface mount LEDs that emit red light having wavelengths between about 620 nanometers and approximately 680 nanometers. In one particular example, the red LEDs emit light having wavelengths of about 660 nanometers. In other examples, the LEDs may emit, for example, other colors of visible light, such as orange, yellow, and/or green, or white light having a broad range of wavelengths.

In one example, the sheath 40 is substantially transparent to the wavelengths of visible light emitted by the LEDs 30, and prevents objects and liquids from coming into contact with the LEDs and the PCB 20. The sheath 40 may be, for example, formed from a plastic material or a rugged type of glass. Suitable plastic materials include acrylic plastic resins such as Plexiglas® (Atofina Chemicals, Inc., Philadelphia, Pa.) and polycarbonate resins such as Lexan® (General Electric Company, Schenectady, N.Y.). Suitable rugged types of glass include borosilicate glass such as Pyrex® (Corning Inc., Corning, N.Y.). One skilled in the art would understand that the examples of materials with which the sheath 40 may be made are not exclusive and that other materials may be used without affecting the scope and/or spirit of the present disclosure.

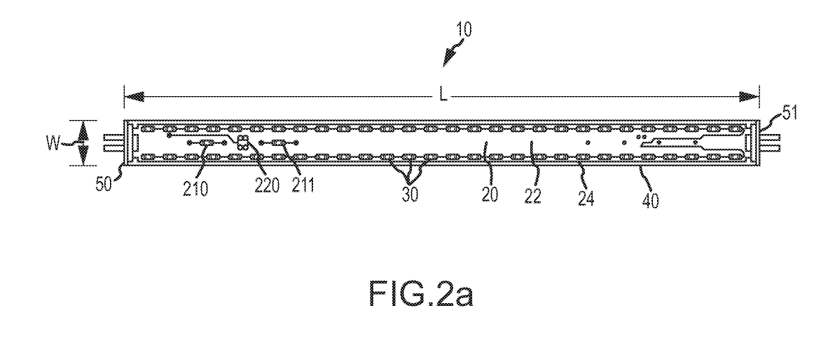

FIG. 2a illustrates a first example of a side elevation view of the tubular light emitting diode lamp 10 of FIG. 1. As illustrated in FIG. 2, the first side 22 of the PCB 20 is visible through the sheath 40. In the example shown in FIG. 2, the LEDs 30 are mounted along opposite edges of the first side 22. Conductive traces of the PCB 20 connect the LEDs 30 in series. It should be understood that while the present example includes two groups of LEDs mounted along opposite edges of the first side 22, the tubular light emitting diode lamp 10 may include alternative numbers of LEDs, and groups of LEDs.

In one example, the tubular light emitting diode lamp 10 has a length dimension “L” of about 11.42 inches, and a width dimension “W” of approximately 0.75 inch. The sheath 40 has an outer diameter of about 0.75 inches and an inner diameter of approximately 0.63 inches. It should be noted that the above dimensions L and W of the tubular light emitting diode lamp 10 are substantially similar to corresponding dimensions of industry standard T8 fluorescent lamps. For example, the tubular light emitting diode lamp 10 may replace a preheat-type (or instant or rapid start) T8 fluorescent lamp in a light fixture having lamp holders for receiving T8 fluorescent lamps. One skilled in the art would understand that the example dimensions illustrated for the tubular light emitting diode lamp 10 are not exclusive or limiting. Other “L”, “W” and sheath inner and outer diameter dimensions, which may correspond to other size (e.g., T5) fluorescent lamps, are also within the scope and spirit of the present disclosure.

Also shown in FIG. 2a are a first resistor 210, a bridge rectifier integrated circuit (IC) 220, and a second resistor 211 of an electric circuit for providing proper electrical voltage and current to the array of LEDs on the PCB 20.

In another example, FIG. 2b illustrates a second example of a side elevation view of the tubular light emitting diode lamp 10 of FIG. 1. In FIG. 2b, the tubular light emitting diode lamp 10 includes LEDs 30 mounted along three rows (first row, second row, third row) of the first side 22. FIG. 2b shows the three rows of LEDs wherein the first LED 31, 32, 33, respectively, of each of the three rows are not aligned with each other. In one example, wherein the LEDs of the first row and the third row are paired in alignment to each other and the LEDs of the second row are offset from the LEDs of the first and third rows. However, one skilled in the art would understand that other options may include having the three rows of LEDs aligned with one another or having the three rows of LEDs not aligned with one another in a different alignment pattern not shown in FIG. 2b. For example, the LEDs of the first row is offset from the LEDs of the second row and also offset from the LEDs of the third tow. And, one skilled in the art would understand that although two and three rows of LEDs are illustrated in the examples of FIGS. 2a and 2b respectively, that other quantities of rows of LEDs are not precluded and are within the scope and spirit of the present disclosure. In one example, the other features of the tubular light emitting diode lamp 10 shown in FIG. 2a may apply to the tubular light emitting diode lamp 10 shown in FIG. 2b.

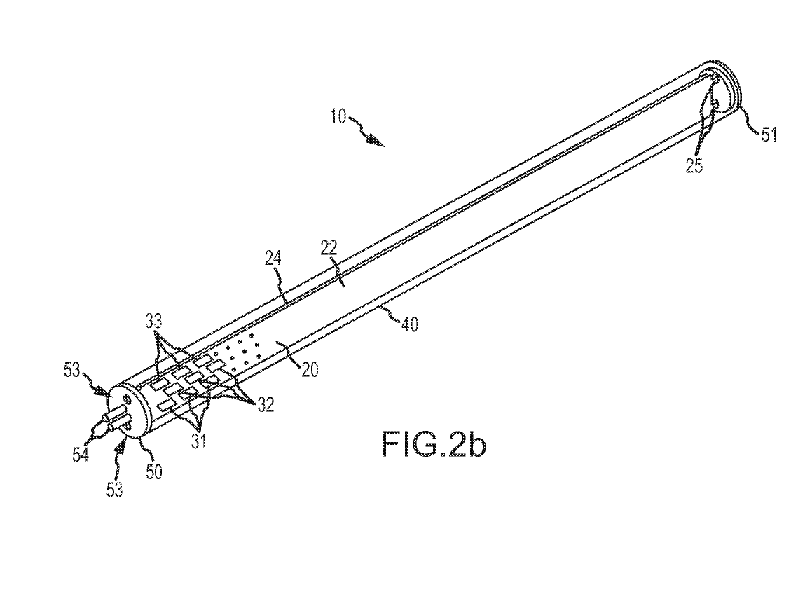

FIG. 3a illustrates a side elevation view of the example tubular light emitting diode lamp 10 shown in FIG. 1 where a second side 24 of the planar printed circuit board (PCB) 20 opposite a first side 22 is visible through a sheath 40 (the sheath 40 is not shown). Similar to the LEDs of FIG. 2a, a second plurality of LEDs 35 are mounted along opposite edges of the second side 24 of the PCB 20. In one aspect, the second plurality of LEDs 35 is mounted along two edges of the second side 24. In one example, the second side 24 includes conductive traces of the PCB 20 to connect the second plurality of LEDs 35 in series. Although LEDs 35 are shown in FIG. 3a to extend along the two edges from the electrical end cap 50 to the non-electrical end cap 51, one skilled in the art that other patterns of LEDs 35 mounted on the second side 24 is another option. For example, the LEDs 35 may be mounted on one or both edges of PCB 20, but may not extend from the electrical end cap 50 to the non-electrical end cap 51. In another example, the LEDs 35 may be mounted in a cluster formation on the second side 24.

FIG. 3b illustrates an example of the second plurality of LEDs mounted on the second side of the PCB. In one aspect, the second plurality of LEDs mounted on the second side are arranged in a single row along the PCB to extend between the electrical end cap 50 and the non-electrical end cap 51. Although FIG. 3b illustrates the LEDs 35 as equidistantly spaced from each other in the single row, the LEDs 35 may also be non-equidistantly spaced from each other. Also, even though more than one LEDs 35 are shown in FIG. 3b, the quantity of LEDs 35 mounted on the second side may vary, and in one example, only one LED 35 is mounted on the second side. In one example, the second plurality of LEDs is mounted substantially perpendicular to the second side of the PCB. In one example, the other features of the tubular light emitting diode lamp 10 shown in FIG. 3a may apply to the tubular light emitting diode lamp 10 shown in FIG. 3b.

One skilled in the art would understand that other arrangements of the LEDs 35 are within the scope and spirit of the present disclosure. In one aspect, one or more of the second plurality of light-emitting diodes (LEDs) 35 is mounted substantially perpendicular along a second side 24 of the substantially planar printed circuit board (PCB) 20.

In one aspect, with the mounting of one or more LEDs 30 on the first side 22 and one or more LEDs 35 on the second side 24 of the PCB 20, the LEDs 30, 35 divergently emit light in an angle greater than 180 degrees.

Also shown in FIG. 3a are a first resistor 310, a bridge rectifier IC 320, and a second resistor 311 of an electric circuit for providing proper electrical voltage and current to the array of LEDs 35 on the second side 24 of the PCB 20.

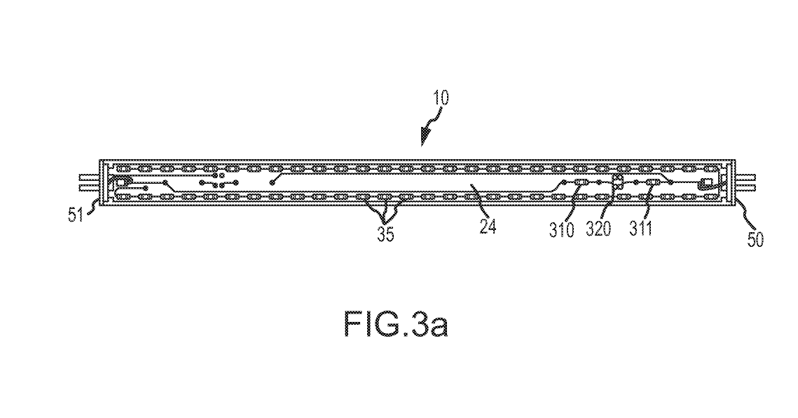

FIG. 4 illustrates an example circuit diagram of an electrical circuit 400 for properly illuminating the LEDs 30 and 35 forming respective LED arrays 430 and 450 of the tubular light emitting diode lamp 10 of FIGS. 1, 2a, 2b and 3. In one aspect, the electrical circuit 400 includes two substantially similar sections 410 and 420. The section 410 provides proper electrical voltage and current to the LEDs 30 of the LED array 430, and the section 420 provides proper electrical voltage and current to the LEDs 35 of the LED array 450.

In one example, the section 410 includes the resistor 310 (shown in FIG. 3a), a bridge rectifier circuit 470 within the bridge rectifier IC 320 (shown in FIG. 3a), and the resistor 311 (shown in FIG. 3a). In one example, the pins 54 (shown in FIG. 1) are connected to wires associated with sections 410 and/or 420 to provide electrical power to the LEDs. In one example, the bridge rectifier circuit 470 receives 120 volts alternating current “VAC” provided to the pins 54 and rectifies the alternating current (ac) voltage. The resistors 310, 311 are valued to achieve an electrical current through the LEDs 30 for proper illumination. In one example, the section 420 includes the resistor 210 (shown in FIG. 2a), a bridge rectifier circuit 472 within the bridge rectifier IC 220 (shown in FIG. 2a), and the resistor 211 (shown in FIG. 2). For example, the bridge rectifier circuit 472 receives the 120 VAC and rectifies the ac voltage. The resistors 210, 211 are valued to achieve an electrical current through the LEDs 35 for proper illumination. Although two distinct sections 410 and 420 are illustrated, one skilled in the art would understand that a single section or multiple sections (greater than two sections) may be implemented to illuminate the LEDs 30 and 35.

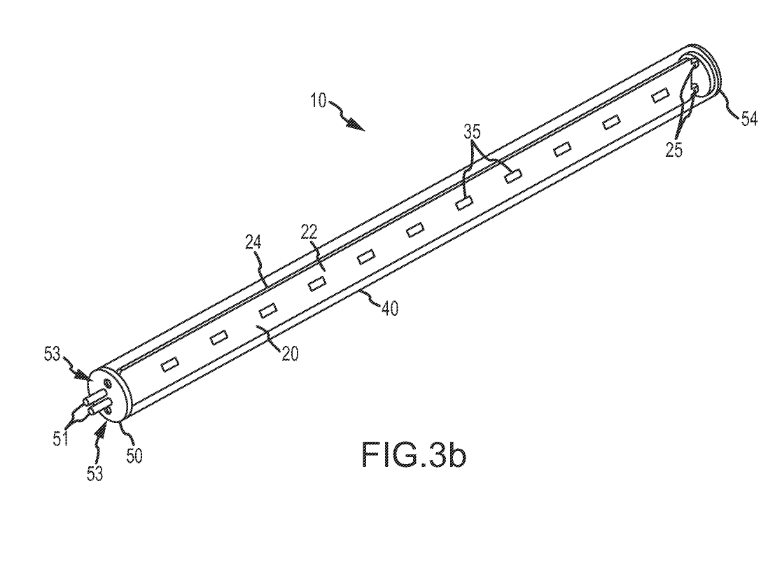

FIG. 5 illustrates an example of a light fixture 500 for housing a tubular light emitting diode lamp 10. The light fixture 500 may include a guard 510 positioned over a prismatic lens 520. In one example, the prismatic lens 520 includes pyramid-shaped refracting prisms on one side. The refracting prisms distribute the light emitted by the tubular light emitting diode lamp 10.

The prismatic lens 520 is substantially transparent to the wavelengths of visible light emitted by the LEDs of the tubular light emitting diode lamp 10. The prismatic lens 520 may be, for example, formed from a plastic material or a rugged type of glass. Suitable plastic materials for the prismatic lens 520 may include acrylic plastic resins such as Plexiglas® (Atofina Chemicals, Inc., Philadelphia, Pa.) and polycarbonate resins such as Lexan® (General Electric Company, Schenectady, N.Y.). Suitable rugged types of glass include borosilicate glass such as Pyrex® (Corning Inc., Corning, N.Y.). In example, the light fixture 500 meets the requirements of the generally available U.S. military specification MIL-F-16377/59A(SH) entitled “FIXTURES, LIGHTING; FLUORESCENT, DETAIL LIGHTING FOR STEP ILLUMINATION” dated 9 May 1983, incorporated herein by reference in its entirety.

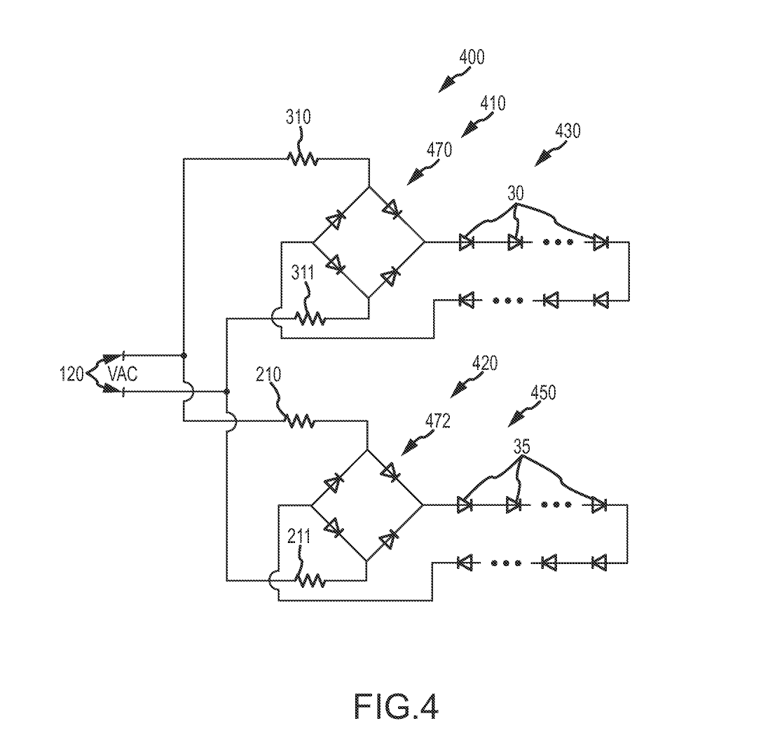

FIG. 6 illustrates a front elevation view of the example light fixture 500 shown in FIG. 5. In one example, the light fixture 500 includes a cable entrance assembly 610 for receiving an electrical cable 620. The electrical cable 620 may include two electrical wires for providing 120 VAC to the tubular light emitting diode lamp 10 housed within the light fixture 500. In one example, the light fixture 500 has a length dimension “L” of about 13.84 inches. However, one skilled in the art would understand that the dimensions of the light fixture 500 may vary from the examples listed in the present disclosure and still be within the spirit and scope of the present disclosure.

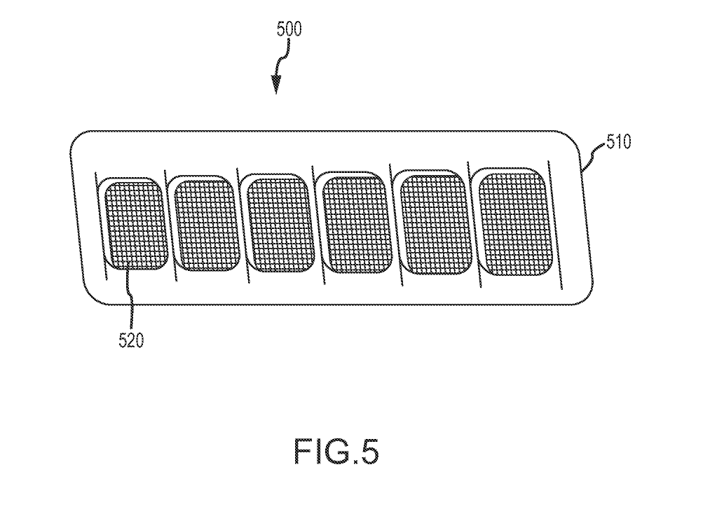

FIG. 7 illustrates a cross-section view (along line 7-7) of the example light fixture 500 as indicated in FIG. 6. As described above, the prismatic lens 520 is positioned between the guard 510 and an enclosure 730 housing the tubular light emitting diode lamp 10. Two bi-pin lamp holders 720 and 721 positioned in the enclosure 730 receive the pins 54 and 55 of the tubular light emitting diode lamp 10. (See FIG. 1.) A reflector 710 positioned within the enclosure 730 reflects light emitted by the tubular light emitting diode lamp 10 toward the prismatic lens 520.

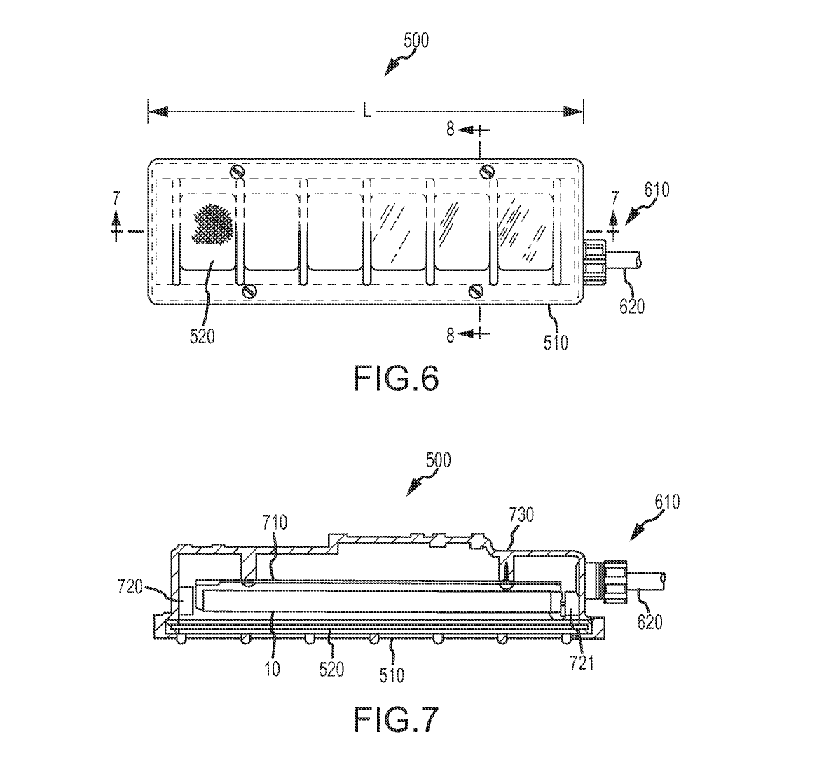

FIG. 8 is another cross-section view (along line 8-8) of the example light fixture 500 as indicated in FIG. 6. In the example of FIG. 8, the light fixture 500 has a height dimension “H” of about 4.41 inches. However, one skilled in the art would understand that the dimensions of the light fixture 500 may vary from the examples listed in the present disclosure and still be within the spirit and scope of the present disclosure.

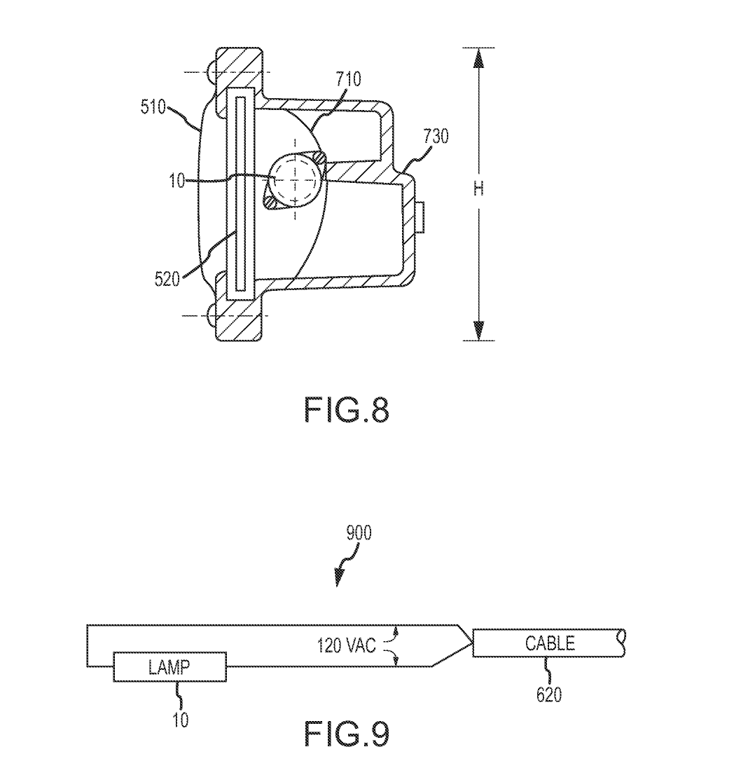

FIG. 9 illustrates an example of a circuit 900 for applying electrical power to a tubular light emitting diode lamp 10 housed in a light fixture 500. In the present example of FIG. 9, the electrical cable 620 has a wire carrying 120 VAC connected to the electrical end cap 50 of the tubular light emitting diode lamp 10. More specifically, the wire is connected to pins 54 (shown in FIG. 1) at end of the tubular light emitting diode lamp 10 via one of the lamp holders 720 or 721 (shown in FIG. 7).

In one example, for a hardware implementation, one or more processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof.

In one example, the illustrative components, flow diagrams, logical blocks, modules and/or algorithm steps described herein are implemented or performed with one or more processors. In one aspect, the one or more processors is coupled with a memory which stores data, metadata, program instructions, etc. to be executed by the processor for implementing or performing the various flow diagrams, logical blocks and/or modules described herein.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A tubular light-emitting diode (LED) lamp comprising:
a planar printed circuit board (PCB) with a first side and a second side, wherein the planar PCB is positioned within a tubular sheath;
a first plurality of light-emitting diodes (LEDs) mounted on the first side, wherein at least one of the first plurality of LEDs is mounted substantially perpendicular to the first side;
a second plurality of LEDs mounted on the second side, wherein at least one of the second plurality of LEDs is mounted substantially perpendicular to the second side;
an electrical end cap coupled at a first end of the planar PCB; and
a non-electrical end cap coupled at a second end of the planar PCB, wherein the first end and the second end are at opposite ends of the tubular sheath.

2. The tubular LED lamp of claim 1, further comprising a capacitor reactance ballasted power supply for supplying electrical voltage to the first plurality of LEDs and the second plurality of LEDs.

3. The tubular LED lamp of claim 1, wherein the electrical end cap is an electrical bi-pin connector end cap.

4. The tubular LED lamp of claim 3, wherein the non-electrical end cap is a mechanical support bracket.

5. The tubular LED lamp of claim 1, wherein the first plurality of LEDs are arranged in three rows, wherein a second row is situated between a first row and a third row.

6. The tubular LED lamp of claim 5, wherein the LEDs of the first row and the third row are paired in alignment to each other and the LEDs of the second row are offset from the LEDs of the first and third rows.

7. The tubular LED lamp of claim 6, wherein the second plurality of LEDs mounted on the second side is arranged in a single row along the PCB.

8. The tubular LED lamp of claim 7, wherein the first plurality of LEDs and the second plurality of LEDs divergently emit light in an angle greater than 180 degrees.

9. The tubular LED lamp of claim 5, wherein the LEDs of the first row, the second row and the third row are mounted on the first side in alignment to each other.

10. The tubular LED lamp of claim 9, wherein the second plurality of LEDs mounted on the second side is arranged in a single row along the PCB.

11. A tubular light-emitting diode (LED) lamp comprising:
a planar printed circuit board (PCB) with a first side and a second side, wherein the planar PCB is positioned within a tubular sheath;
a first plurality of light-emitting diodes (LEDs) mounted on the first side, wherein a substantial quantity of the first plurality of LEDs is mounted substantially perpendicular to the first side;
a second plurality of LEDs mounted on the second side, wherein the second plurality of LEDs is mounted substantially perpendicular to the second side;
an electrical end cap coupled at a first end of the planar PCB;
a non-electrical end cap coupled at a second end of the planar PCB, wherein the first end and the second end are at opposite ends of the tubular sheath; and
a capacitor reactance ballasted power supply for supplying electrical voltage to the first plurality of LEDs and the second plurality of LEDs.

12. The tubular LED lamp of claim 11, wherein the electrical end cap is an electrical bi-pin connector end cap.

13. The tubular LED lamp of claim 12, wherein the non-electrical end cap is a mechanical support bracket.

14. The tubular LED lamp of claim 11, wherein the first plurality of LEDs is arranged in three rows, wherein a second row is situated between a first row and a third row.

15. The tubular LED lamp of claim 14, wherein the LEDs of the first row and the third row are paired in alignment to each other and the LEDs of the second row are offset from the LEDs of the first and third rows.

16. The tubular LED lamp of claim 15, wherein the second plurality of LEDs mounted on the second side is arranged in a single row along the PCB.

17. The tubular LED lamp of claim 16, wherein the first plurality of LEDs and the second plurality of LEDs divergently emit light in an angle greater than 180 degrees.

18. The tubular LED lamp of claim 11, wherein the first plurality of LEDs is arranged in two rows on the first side and the second plurality of LEDs mounted on the second side is arranged in a single row along the PCB.

19. The tubular LED lamp of claim 18, wherein the first plurality of LEDs is mounted along opposite edges of the first side.

20. The tubular LED lamp of claim 19, wherein each of the second plurality of LEDs is mounted equidistant from another LED of the second plurality of LEDs.
